(19) United States
(12) Patent Application Publication
(10) Pub. No.: US 2007/0263409 A1
(43) Pub. Date: Nov. 15, 2007

(54) Light guide plate with reflective light mixing

(76) Inventor: Thye Linn Mok, Bukit Mertajam (MY)

Correspondence Address: Kathy Manke;Avago Technologies Limited, 4380 Ziegler Road, Fort Collins, CO, 80525, US

(21) Appl. No.: 11/430,698

(22) Filed: May 9, 2006

(51) Int. Cl. F21V 7/04

(52) U.S. Cl. 362/612; 362/613; 362/622; 362/609; 362/601

(57) ABSTRACT

A lighting system includes multiple lighting elements, a light guide, and a first selective wavelength reflective element for mixing light outside of the light guide. The lighting elements include a first lighting element having a first wavelength. The light guide receives light from the lighting elements. The first selective wavelength reflective element is positioned between the first lighting element and the light guide to partially transmit light of the first wavelength to the light guide, and to partially reflect light of the first wavelength. Partially reflecting light away from the light guide allows a fraction of the light to be mixed with another color of light prior to entering the light guide. By mixing multiple colors of light outside of the light guide in this manner, discoloration of the LCD panel may be limited or eliminated. Additionally, oversizing the diffusion panel may be limited or eliminated.

### BACKGROUND OF THE INVENTION

Most liquid crystal display (LCD) panels use backlighting to provide a bright image to the viewer. Backlighting is typically provided by diffusing white light from a fluorescent light source or several light emitting diode (LED) sources. To provide evenly distributed backlighting, LCD panels have a diffusion panel that receives the light along one edge of the panel and diffuses the light throughout the face of the diffusion panel. The white light may be directly generated by the fluorescent light source or the LEDs. However, colored LEDs emitting such colors as red, green, and blue (RGB) are also used in some applications. Where colored LEDs are used, the different colors are mixed to create the white light. This mixing typically occurs within a portion of the diffusion panel near the LEDs. Using a portion of the diffusion panel to mix the colored lights from the LEDs causes noticeable discoloration on the LCD panel. To avoid such discoloration, some LCD panels have oversized diffusion panels which use the additional area (i.e., the area not used to light the LCD panel) to mix the colors from the LEDs. However, enlarging the diffusion panel increases the cost of manufacturing and requires larger package dimensions.

In view of this, what is needed is a light mixing solution to overcome the problems of discoloration and oversizing the diffusion panel.

### SUMMARY OF THE INVENTION

A lighting system is described. One embodiment of the lighting system includes a plurality of lighting elements, a light guide, and a first selective wavelength reflective element. The plurality of lighting elements includes a first lighting element having a first wavelength. The light guide receives light from the plurality of lighting elements. The first selective wavelength reflective element is positioned between the first lighting element and the light guide to partially transmit light of the first wavelength to the light guide, and to partially reflect light of the first wavelength. Partially reflecting light away from the light guide allows a fraction of the light to be mixed with another color of light prior to entering the light guide. In particular, the reflected light may disperse more and mix with other colors from nearby LEDs. By mixing multiple colors of light outside of the light guide in this manner, discoloration of the LCD panel may be limited or eliminated. Additionally, oversizing the diffusion panel may be limited or eliminated.

A method for mixing light is also described. One embodiment of the method includes providing a selective wavelength reflective element between a plurality of lighting elements and a light guide. Each of the plurality of lighting elements is coupled to a base and emits one of a plurality of selective wavelength lights. The method also includes reflecting a first wavelength of the plurality of selective wavelength lights between the light guide and the base to mix the plurality of selective wavelength lights.

Another embodiment of an apparatus to mix light is described. The apparatus includes means for generating a plurality of lights having a plurality of wavelengths, means for transmitting the plurality of lights to an effective area of a light guide, and means for mixing the plurality of lights within a mixing distance outside of the light guide.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a conventional light mixing system which uses an oversized light guide plate.

FIG. 2 depicts a light mixing diagram corresponding to the conventional light mixing system.

FIG. 3 depicts an embodiment of a light mixing system which facilitates an increased effective area of an oversized light guide plate.

FIG. 4 depicts another embodiment of a light mixing system having a non-oversized light guide plate.

FIG. 5 depicts an embodiment of several light emitting diodes (LEDs) and corresponding selective wavelength reflective elements to facilitate light outside of the light guide plate.

FIG. 6 depicts an embodiment of a light mixing diagram corresponding to the light mixing system for mixing light outside of the light guide plate.

FIG. 7 depicts a perspective view of an embodiment of a selective wavelength reflective film applied to the light guide plate.

FIG. 8 is a process flow diagram of a light mixing method which may be used in conjunction with the lighting mixing system.

Throughout the description, similar reference numbers may be used to identify similar elements.

### DETAILED DESCRIPTION

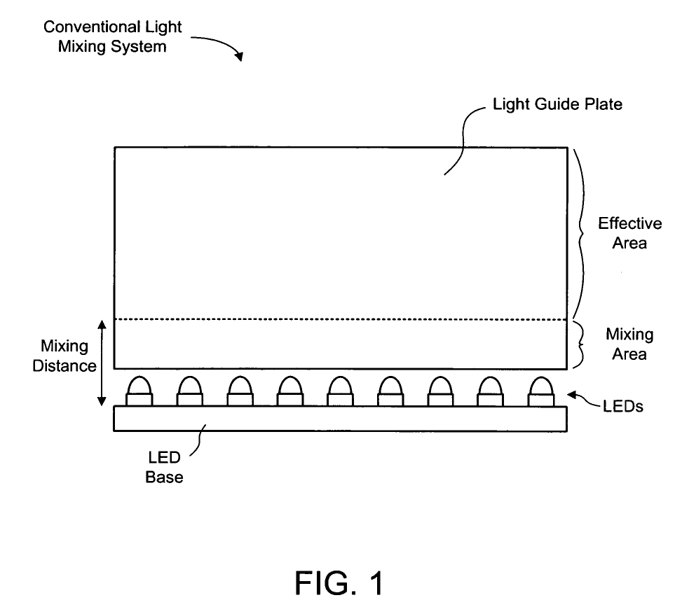

FIG. 1 depicts a conventional light mixing system which uses an oversized light guide plate. One example of a light guide plate is a diffusion panel such as may be used in a liquid crystal display (LCD) panel. Colored light from several light emitting diodes (LEDs) is transmitted into the light guide plate. The LEDs are mounted in a row on an LED base such as a circuit board. Red, green, and blue LEDs are conventionally used. The colored light is mixed together over a mixing distance, which typically overlaps with at least a portion of the light guide plate. The colored lights from the LEDs are not fully mixed in portions of the light guide plate within the mixing distance, potentially causing discoloration on the LCD panel. The discoloration may be visible to the viewer.

To reduce the visible discoloration on the LCD panel, the LCD panel is oversized so that the mixing area (i.e., the area of the light guide panel within the mixing distance from the LEDs) is not visible to the viewer. Some LCD panels “black out” the mixing area so that it is not visible to the viewer. Whether or not the mixing area of the LCD panel is visible to the viewer, the light guide plate has a limited effective area, which is the area of the light guide plate in which the colored lights are substantially mixed so that there is no discoloration visible to the viewer.

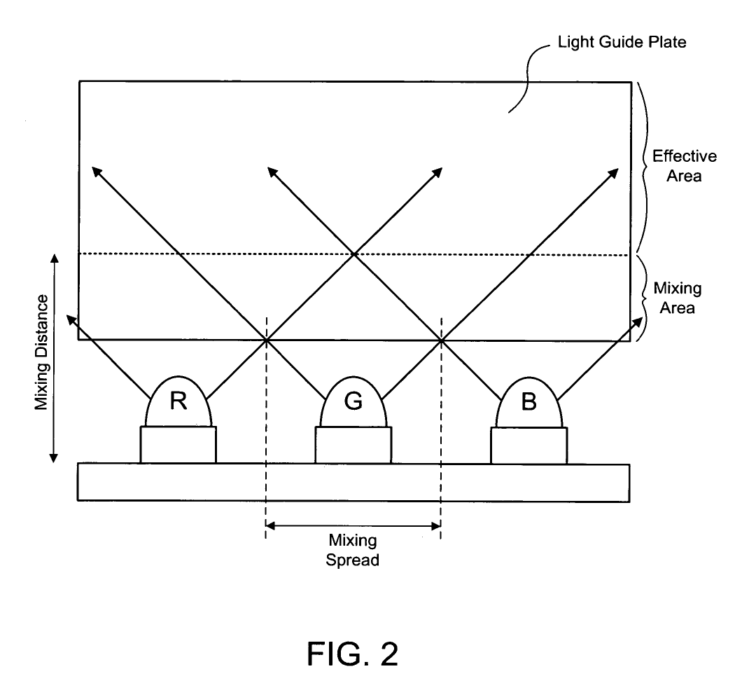

FIG. 2 depicts a light mixing diagram corresponding to the conventional light mixing system. The conventional light mixing diagram illustrates a row of three LEDs: a red (R) LED, a green (G) LED, and a blue (B) LED. The red, green, and blue lights from the corresponding LEDs are not fully mixed until approximately the mixing distance. As described above with reference to FIG. 1, the mixing distance is conventionally some distance overlapping the light guide plate. Although the light from adjacent LEDs may mix in a shorter distance than the mixing distance, the light from non-adjacent LEDs requires a greater distance to mix. For example, it is not until about the mixing distance that the red and blue light finally mix together, even though the red and blue lights individually mixed with the green light in a shorter distance.

In specific configurations, the mixing distance may depend on a variety of factors, including the number and linear spacing of the LEDs, as well as the beam widths of the individual LEDs. Similarly, the size of the mixing area of the light guide plate may depend on the mixing distance, the size of the effective area of the light guide plate, the distance from the LEDs to the transmission interface (i.e., the edge closest to the LEDs) of the light guide panel, and so forth.

For purposes of performance evaluation, a mixing spread is also shown. In one embodiment, the mixing spread indicates the width of the light distribution of an LED (e.g., the green LED) at the point where the light enters the light guide plate. In the illustrated example, the mixing spread of the green LED is approximately equal to the distance between adjacent LEDs (e.g., the distance between the red LED and the green LED).

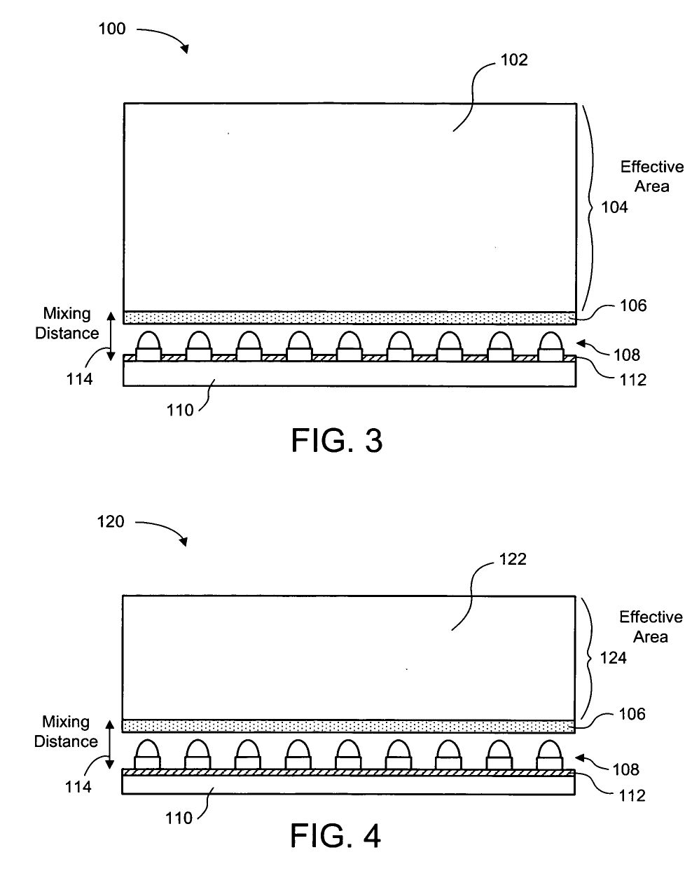

FIG. 3 depicts an embodiment of a light mixing system I 00 which includes an oversized light guide plate 102 with an increased effective area 104. Although the described light mixing system includes a light guide plate 102, other light mixing systems may include other types of light guides. For example, a fiber optic cable is another type of light guide which is not a plate or panel.

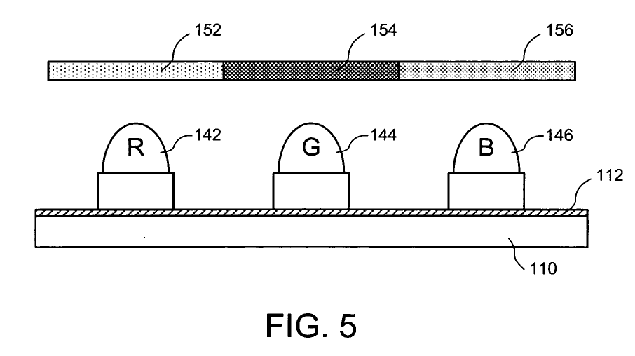

The illustrated light mixing system 100 includes a selective wavelength reflective film 106 applied to the transmission interface of the light guide plate 102. The transmission interface is the location at which the light from the LEDs 108 enters the light guide plate 102. In one embodiment, the selective wavelength reflective film 106 may be a single, continuous film. Alternatively, the selective wavelength reflective film 106 may include several non-contiguous portions. In a further embodiment, another material other than a film may be used. For example, other implementations may include plates, lenses, or other structures which are not necessarily a film. A more detailed explanation of an embodiment of the selective wavelength reflective film 106 is shown in and described with reference to FIG. 5.

In one embodiment, the LEDs 108 are coupled to an LED base 110. The LED base 1 10 may be a circuit board, although other types of LED bases 110 may be used. Alternatively, the LEDs 108 may be integrated into a printed circuit board or coupled to another type of circuit structure. The light mixing system 100 also may include a reflective layer 112 applied to the LED base 1 10. The reflective layer 112 may be applied between the individual LEDs 108 or, alternatively, in another position at approximately the location of the LEDs 108 and the LED base 110. The functionality of the reflective layer 112 is described in more detail below with reference to FIG. 5.

By implementing the light mixing system 100 with the selective wavelength reflective film 106 and the reflective layer 112, the colored lights from the LEDs 108 may be mixed as at least a fraction of the colored lights are reflected between the selective wavelength reflective film 106 and the reflective layer. More details of how this mixing may be performed are provided below. Mixing the colored lights through reflection before they are fully transmitted into the light guide plate 102 allows all or substantially all of the light guide plate 102 to be used as an effective area 104. Where an oversized light guide plate 102 is used, the light mixing system 100 may allow more of the oversized light guide plate 102 to be used as an effective area 104, rather than as a relatively inefficient mixing area.

FIG. 4 depicts another embodiment of a light mixing system 120 having a non-oversized light guide plate 122. The light mixing system 120 is similar to the light mixing system 100 of FIG. 3, except that the light guide plate 122 shown in FIG. 4 is not oversized. As an alternative to increasing the effective area 104 of an oversized light guide plate 102, as described above and shown in FIG. 3, the overall size of the light guide plate 124 may be reduced to approximately the same as the size of the LCD panel. By using reflection to mix the colored lights between the LED base 110 and the transmission interface of the light guide plate 122, the mixing area may be minimized or eliminated. Accordingly, the mixing distance 114 may be minimized so that it is approximately the same as the distance between the LED base 110 and the transmission interface of the light guide plate 122. Eliminating the mixing area from the light plate guide 122 allows substantially all of the light plate guide 122 to be used as an effective area 124, even if the light plate guide 122 is not oversized.

The light mixing system 120 also illustrates an alternative placement of the reflective layer 112. Although the reflective layer 112 may be coupled to the LED base 110 or LEDs 108 in various manners, one embodiment includes the reflective layer 112 applied between the LED base 110 and the LEDs 108.

For convenience, the following references to the light mixing system 100 and the light guide plate 102 are intended to refer to one or more embodiments, generally, unless explicitly or contextually indicated otherwise.

FIG. 5 depicts an embodiment of several LEDs 142, 144, and 146 and corresponding selective wavelength reflective elements 152, 154, and 156 to facilitate reflecting light outside of the light guide plate 102. The light guide plate 102 is omitted from FIG. 5 for convenience and clarity, but may be positioned above the selective wavelength reflective elements 152, 154, and 156. The LEDs 142, 144, and 146 are similar to the LEDs 108 described above. Similarly, the selective wavelength reflective elements 152, 154, and 156 are similar to the selective wavelength reflective film 106 described above. The LEDs 142, 144, and 146 are coupled to a LED base 110, and a reflective layer 112 is applied to the LED base 110, as described above.

In one embodiment, the first LED 142 is a red LED (designated with an “R”) and the first selective wavelength reflective element 152 is a red reflective element; the second LED 144 is a green LED (designated with a “G”) and the second selective wavelength reflective element 154 is a green reflective element; and the third LED 146 is a blue LED (designated with a “B”) and the second selective wavelength reflective element 156 is a blue reflective element. In this manner, each LED 142, 144, and 146 is aligned with a selective wavelength reflective element 152, 154, and 156 of a corresponding color.

Each of the selective wavelength reflective elements 152, 154, and 156 is configured to reflect at least a fraction of the light from the corresponding LEDs 142, 144, and 146. For example, the red reflective element reflects at least some of the red light from the red LED; the green reflective element reflects at least some of the green light from the green LED; and the blue reflective element reflects at least some of the blue light from the blue LED. The light that is not reflected transmits, or propagates, through the selective wavelength reflective elements 152, 154, and 156 into the light guide plate 102. Additionally, each of the selective wavelength reflective elements 152, 154, and 156 may transmit all or substantially all of the light from the non-corresponding LEDs 142, 144, and 146. For example, the red reflective element transmits substantially all of the green and blue lights; the green reflective element transmits substantially all of the red and blue lights; and the blue reflective element transmits substantially all of the red and green lights.

In one embodiment, the amount of each colored light that is transmitted through or reflected by a given reflective element may depend on the color (i.e., wavelength) of the light, the construction of the reflective element, the intensity of the incident light, and so forth. Furthermore, where multiple reflective elements are used in a single light mixing system 100, each of the reflective elements may be configured to transmit and reflect different fractions of each color of light in order to produce a predetermined resulting mixture of the colored lights. For example, the red reflective element may reflect 50% of the red light, while the green reflective element may reflect 45% of the green light, and the blue reflective element may reflect 65% of the blue light. By varying the reflectivity of multiple reflective elements, the resulting color or brightness of the mixed, diffused light in the light guide plate 102 may be optimized.

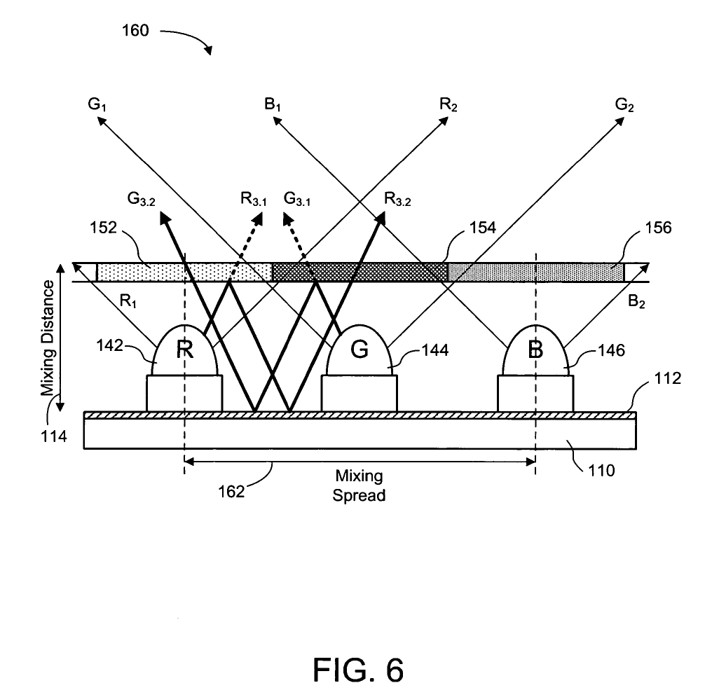

FIG. 6 depicts an embodiment of a light mixing diagram 160 corresponding to the light mixing system 100 for mixing light outside of the light guide plate 102. Similar to the embodiment shown in FIG. 5, several LEDs 142, 144, and 146 and corresponding selective wavelength reflective elements 152, 154, and 156 facilitate reflecting and mixing light outside of the light guide plate 102. For convenience in describing the light ray diagram 160 and functionality of the light mixing system 100, the red reflective element 152 corresponds to the red LED 142; the green reflective element 154 corresponds to the green LED 144; and the blue reflective element 156 corresponds to the blue LED 146. However, other embodiments may implement different correspondences. Additionally, certain embodiments may implement reflective elements of non-uniform sizes or configurations.

The reflective layer 112 also facilitates reflecting and mixing light outside of the light guide plate 102. In one embodiment, the reflective layer 112 reflects substantially all of the colored light. Although this description may emphasize mixing light outside the light guide plate 102, such mixing does not preclude the possibility of mixing some of the light within the light guide plate 102 as well, as the various wavelengths propagate through the light guide plate 102.

In the illustrated embodiment, three red light rays, R1, R2, and R3, are depicted propagating from the red LED 142. Similarly, three green light rays, G1, G2, and G3, are depicted propagating from the green LED 144, and two blue light rays, B1 and B2, are depicted propagating from the blue LED 146. Although a particular number of light rays are shown in the light ray diagram 160, light rays from any of the light sources may propagate in various directions, depending at least in part on the type of light source used and the orientation of the light source relative to the light guide plate 102.

Two red light rays, R1 and R2, are shown propagating through non-corresponding reflective elements such as a green reflective element 154 and another reflective element on the opposite side of the red reflective element 152. Likewise, two green light rays, G1 and G2, are shown propagating through non-corresponding red and blue reflective elements 152 and 156. Similarly, two blue light rays, B1 and B2, are shown propagating through the non-corresponding green reflective element 154 and another reflective element on the opposite side of the blue reflective element 156. In one embodiment, these light rays propagating through non-corresponding reflective elements are not reflected (or are minimally reflected) and substantially propagate through the transmission interface of the light guide plate 102 and into the light guide plate 102 on the other side of the reflective elements.

However, not all of the light rays from each of the LEDs 142, 144, and 146 necessarily propagate directly into the light guide plate 102. Rather, the light rays that are incident on a corresponding reflective element (e.g., red light incident on the red reflective element 152) may be at least partially reflected and only partially transmitted into the light guide plate 102. One exemplary red light ray, R3, and one exemplary green light ray, G3, (both shown in bold) are substantially reflected by the corresponding red and green reflective elements 152 and 154, respectively. To illustrate this, the dashed arrows, designated as R3.1 and G3.1, represent the fractions of the red and green light rays that are transmitted through the red and green reflective elements 152 and 154. The solid arrows, designated as R3.2 and G3.2, represent the fractions of the red and green light rays that are reflected by the red and green reflective elements 152 and 154.

The reflective layer 112 at the LED base 110 subsequently reflects the red and green light rays R3.2 and G3.2 again, after which they propagate through adjacent non-corresponding reflective elements. In particular, the red light ray, R3.2, may be at least partially reflected between the red reflective element 152 and the reflective layer 112 until it propagates through the adjacent green reflective element 154. Similarly, the green light ray, G3.2, may be at least partially reflected between the green reflective element 154 and the reflective layer 112 until it propagates through the adjacent red reflective element 152. Although the illustrated light rays only reflect once off of each corresponding reflective element and the reflective layer 112, other embodiments may facilitate multiple reflections. With each incident light ray on a corresponding reflective element, an additional fraction of the incident light ray may propagate through the corresponding reflective element and into the light guide plate 102.

As an additional measure of performance of the light mixing system 102 having a light distribution similar to the light ray diagram 160, the mixing spread 162 may be compared to the mixing spread of a conventional light mixing system. In the illustrated example, the mixing spread is approximately the distance between alternating LEDs (e.g., the distance between the red LED 152 and the blue LED 156). Compared to the mixing spread of a conventional light mixing system, the light mixing system 102 substantially increases the mixing spread 162 (e.g., 200% of the conventional mixing spread). While this example illustrates the increased performance of the light mixing system 102 using reflective elements 152, 154, and 156 and a reflective layer 112, the performance characteristics of other embodiments may vary.

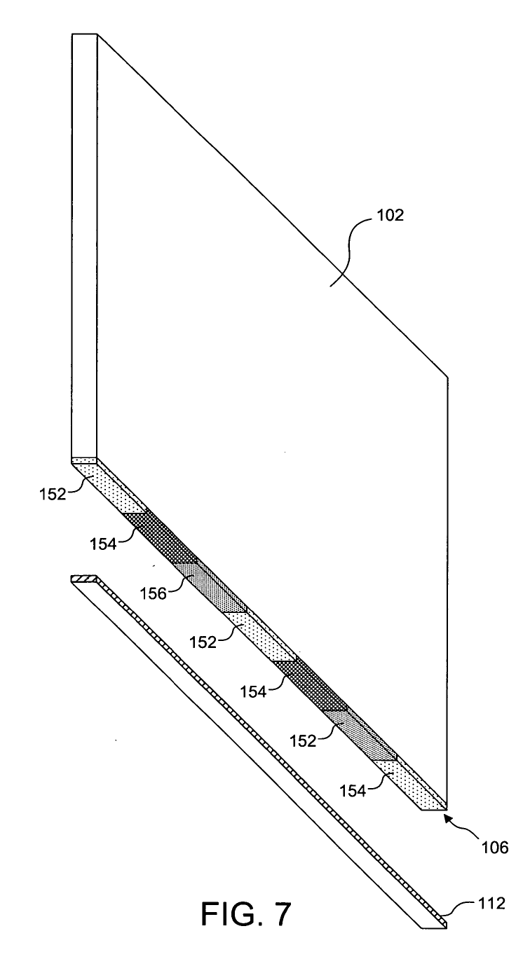

FIG. 7 depicts a perspective view of an embodiment of a selective wavelength reflective film 106 applied to the light guide plate 102. As described above, the selective wavelength reflective film 106 may include several distinct selective wavelength reflective elements 152, 154, and 156. Alternatively, selective wavelength reflective elements 152, 154, and 156 may be applied to the light guide plate 102 as an aggregated film 106. Additionally, the several selective wavelength reflective elements 152, 154, and 156 may have independent shapes and configurations to optimize the mixing performance of the light mixing system 102.

The reflective layer 112 is also shown in a position relative to the selective wavelength reflective film 106. In one embodiment, the reflective layer 112 reflects all wavelengths in a substantially equivalent manner. However, other embodiments of the reflective layer 112 may reflect some wavelengths of light more or less than other wavelengths of light.

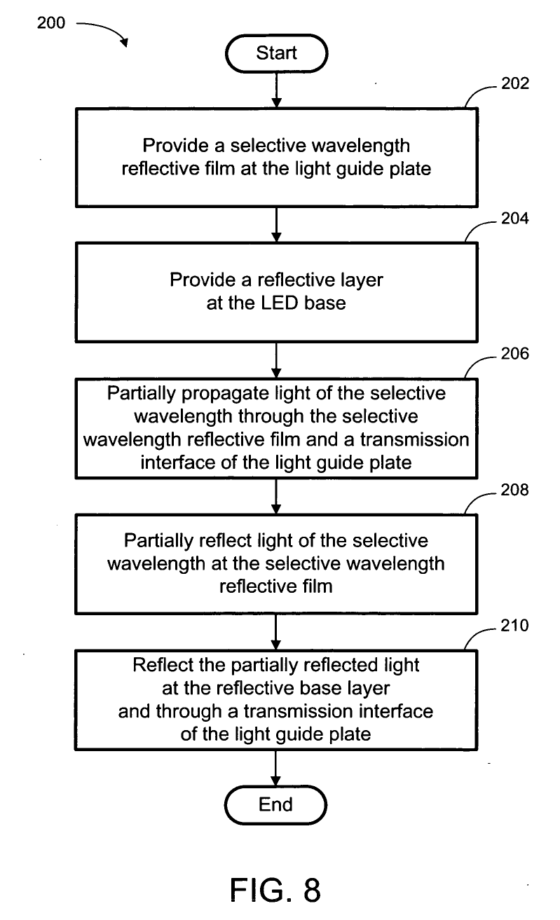

FIG. 8 is a process flow diagram of a light mixing method 200 which may be used in conjunction with the light mixing system 100. Similarly, the light mixing method 200 may be used in conjunction with other light mixing systems. At block 202, a selective wavelength reflective film 106 is provided at the transmission interface of the light guide plate 102. At block 204, a reflective layer 112 is provided at the LED base 110. At block 206, light incident on a corresponding reflective element of the selective wavelength reflective film 106 partially propagates through the selective wavelength reflective film 106 and a transmission interface of the light guide plate 102. At block 208, a fraction of the light incident on the corresponding reflective element of the selective wavelength reflective film 106 reflects away from the light guide plate 102. Although blocks 206 and 208 are shown sequentially, the partial propagation of the light into the light guide plate 102 and partial reflection of the light away from the light guide plate 102 may occur substantially simultaneously. At block 210, the partially reflected light (e.g., from block 208) is again reflected, although at the reflective layer 112, and propagates through the selective wavelength reflective film 106 and into the light guide plate 102.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A lighting system comprising:
a plurality of lighting elements, wherein a first lighting element has a first wavelength;
a light guide to receive light from the plurality of lighting elements; and
a first selective wavelength reflective element between the first lighting element and the light guide to partially transmit light of the first wavelength to the light guide, and to partially reflect light of the first wavelength.

2. The lighting system of claim 1 further comprising a reflective layer approximately located at a base of the plurality of lighting elements, wherein the plurality of lighting elements are coupled to the base.

3. The lighting system of claim 2, wherein the reflective layer has a reflectivity to reflect light of a plurality of wavelengths including the first wavelength.

4. The lighting system of claim 1 further comprising:
a second selective wavelength reflective element between a second lighting element and the light guide to partially transmit and to partially reflect light of the second wavelength; and
a third selective wavelength reflective element between a third lighting element and the light guide to partially transmit and to partially reflect light of the third wavelength.

5. The lighting system of claim 4 wherein:
the first lighting element comprises a red light emitting diode, and the first selective wavelength reflective element comprises a red reflector;
the second lighting element comprises a green light emitting diode, and the second selective wavelength reflective element comprises a green reflector; and
the third lighting element comprises a blue light emitting diode, and the third selective wavelength reflective element comprises a blue reflector.

6. The lighting system of claim 5 wherein:
the red reflector transmits substantially all of a green light and a blue light;
the green reflector transmits substantially all of a red light and the blue light; and
the blue reflector transmits substantially all of the red light and the green light.

7. The lighting system of claim 4 wherein a selective wavelength reflective film comprises the first, second, and third selective wavelength reflective elements.

8. The lighting system of claim 7 wherein the selective wavelength reflective film has a spatially variable reflectivity.

9. The lighting system of claim 7 wherein the selective wavelength reflective film is applied to an edge surface of the light guide.

10. The lighting system of claim 1 wherein substantially all of the light guide comprises an effective area.

11. A method for mixing light comprising:
providing a selective wavelength reflective element between a plurality of lighting elements and a light guide, wherein each of the plurality of lighting elements is coupled to a base and emits one of a plurality of selective wavelength lights; and
reflecting a first wavelength of the plurality of selective wavelength lights between the light guide and the base to mix the plurality of selective wavelength lights.

12. The method of claim 11 further comprising providing a reflective layer at the base to reflect any of the plurality of selective wavelength lights.

13. The method of claim 1 1 further comprising partially transmitting the first wavelength of the plurality of selective wavelength lights into the light guide.

14. The method of claim 11 further comprising aligning a plurality of selective wavelength reflective elements with the plurality of lighting elements, wherein each of the plurality of selective wavelength reflective elements reflects the corresponding plurality of selective wavelength lights.

15. An apparatus to mix light comprising:
means for generating a plurality of lights having a plurality of wavelengths;
means for transmitting the plurality of lights to an effective area of a light guide; and
means for mixing the plurality of lights within a mixing distance outside of the light guide.

16. The apparatus of claim 15 further comprising:
means for reflecting the plurality of lights within the mixing distance; and
means for providing an increased mixing spread of at least one of the means for generating the plurality of lights.

17. The apparatus of claim 16 further comprising means for selectively reflecting a plurality of wavelengths of the plurality of lights at a transmission interface of the light guide.

18. The apparatus of claim 17 wherein the means for reflecting the plurality of lights comprises means for reflecting a first wavelength and means for reflecting a second wavelength.

19. The apparatus of claim 16 further comprising means for reflecting each of the plurality of lights at a base, wherein the means for generating the plurality of lights are coupled to the base.

20. The apparatus of claim 15 further comprising means eliminating substantially all of a blackout area of the light guide.
